(19) United States
(12) Patent Application Publication
(10) Pub. No.: US 2022/0242694 A1
(43) Pub. Date: Aug. 4, 2022

(54) NOTIFICATION APPARATUS, NOTIFICATION SYSTEM, NOTIFICATION METHOD AND NOTIFICATION PROGRAM

(71) Applicant: Nippon Telegraph and Telephone Corporation, Tokyo (JP)

(72) Inventors: Ryo Nagaoka, Musashino-shi, Tokyo (JP); Shuji Kimura, Musashino-shi, Tokyo (JP); Nobuhiro KIMURA, Musashino-shi, Tokyo (JP); Taichi Osada, Musashino-shi, Tokyo (JP); Takashi Yasunaga, Musashino-shi, Tokyo (JP); Yasuharu Yamashita, Musashino-shi, Tokyo (JP); Kaori Isagai, Musashino-shi, Tokyo (JP); Takato Toda, Musashino-shi, Tokyo (JP)

(21) Appl. No.: 17/623,785

(22) PCT Filed: Jul. 5, 2019
(86) PCT No.: PCT/JP2019/026823

§ 371 Date: Dec. 29, 2021

(51) Int. Cl. B66B 3/00; B66B 5/02; H04W 8/00

(52) U.S. Cl. CPC B66B 3/00; H04W 8/005; B66B 5/02

(57) ABSTRACT

A reporting device 1 includes: a starting unit 12 that when emergently stopping an elevator, starts a detection device 3 that is installed in the elevator and senses a radio wave emitted by a mobile terminal 5; a reception unit 13 that receives from the detection device 3 a sensing signal indicating that a radio wave from the mobile terminal 5 has been sensed; and a reporting unit 14 that makes a report to an external system 7 when the reception unit 12 receives the sensing signal.

### TECHNICAL FIELD

The present invention relates to a reporting device, a reporting system, a reporting method, and a reporting program.

### BACKGROUND ART

When an elevator has emergently stopped due to an earthquake, a power outage, or the like, there may be an event where a passenger is trapped in the elevator car. In this case, it is possible to notify the trapped situation by pressing the emergency call button provided in the elevator car to talk with an external monitoring center.

Talking with the outside in the elevator car is described in Non-Patent Literature 1.

### CITATION LIST

### Non-Patent Literature

Non-Patent Literature 1: “Mitsubishi passenger elevator NEXCUBE”, the Internet <URL: http://www.ntt.co.jp/journal/1705/files/jn20170560.pdf>

### SUMMARY OF THE INVENTION

### Technical Problem

In order to notify the external monitoring center, it is necessary to, for example, press the emergency call button. The emergency call button is generally provided in the upper part of the operation panel in the elevator car. For this reason, a child, a person who uses a wheelchair, a person who has lost consciousness due to the impact of a disaster, or the like cannot press the emergency call button, and therefore cannot notify the outside of the situation of being trapped in the elevator car.

The present invention has been made in view of the above circumstances, and an object of the present invention is to provide a technique with which even when a person who cannot press the emergency call button is trapped in an elevator car, it can be reported to the outside that the person is in the trapped state.

### Means for Solving the Problem

In order to achieve the above object, an aspect of the present invention is a reporting device including: a starting unit that when emergently stopping an elevator, starts a detection device that is installed in the elevator and senses a radio wave emitted by a mobile terminal; a reception unit that receives from the detection device a sensing signal indicating that a radio wave from the mobile terminal has been sensed; and a reporting unit that makes a report to an external system when the reception unit receives the sensing signal.

An aspect of the present invention is a reporting system including: a detection device that is installed in an elevator, and transmits a sensing signal when sensing a radio wave emitted by a mobile terminal; and a reporting device, wherein the reporting device includes: a starting unit that starts the detection device when emergently stopping the elevator; a reception unit that receives from the detection device a sensing signal indicating that a radio wave from the mobile terminal has been sensed; and a reporting unit that makes a report to an external system when the reception unit receives the sensing signal.

An aspect of the present invention is a reporting method performed by a reporting device, the reporting method including: a starting step of, when emergently stopping an elevator, starting a detection device that is installed in the elevator and senses a radio wave emitted by a mobile terminal; a reception step of receiving from the detection device a sensing signal indicating that a radio wave from the mobile terminal has been sensed; and a reporting step of making a report to an external system when receiving the sensing signal.

An aspect of the present invention is a reporting program for causing a computer to function as the above reporting device.

### Effects of the Invention

According to the present invention, it is possible to provide a technique with which even when a person who cannot press the emergency call button is trapped in an elevator car, it can be reported to the outside that the person is in the trapped state.

### BRIEF DESCRIPTION OF DRAWINGS

FIG. 1 is a diagram showing an overall configuration of a reporting system according to an embodiment of the present invention.

FIG. 2 is a functional block diagram showing a configuration of a control device.

FIG. 3 is an explanatory diagram showing an operation overview of the reporting system.

FIG. 4 is a flowchart showing operation of the control device.

FIG. 5 is a hardware configuration diagram of the control device.

### DESCRIPTION OF EMBODIMENTS

Hereinafter, an embodiment of the present invention will be described with reference to the drawings. In the description of the drawings, the same parts are given the same reference numeral, and explanation thereof will be omitted.

(Overall Configuration of Reporting System)

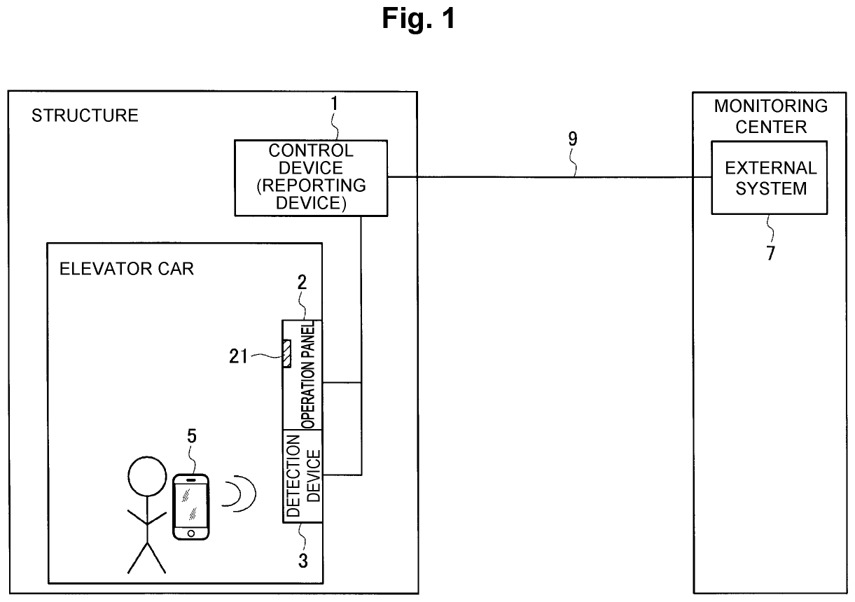

FIG. 1 is an overall configuration diagram of a reporting system of this embodiment. The reporting system shown includes a control device 1 (a reporting device), an operation panel 2, and a detection device 3 that are installed in a structure such as a building and a condominium. The operation panel 2 and the detection device 3 are installed in an elevator (an elevator car) in the structure. Further, the reporting system includes an external system 7. The external system 7 is installed in a monitoring center at a location apart from the structure, and connected to the control device 1 via a network 9.

The control device 1 is a device that controls the elevator. The control device 1 of this embodiment also function as a reporting device that reports the state where a person is trapped in the elevator to the monitoring center. The control device 1 is communicably connected to the operation panel 2 and the detection device 3.

The operation panel 2 is a user interface for a person to operate the elevator. The operation panel 2 has a talking device 21 (an intercom) for talking with an operator in the monitoring center, etc. An emergency call button that is a part of the talking device 21 is an input device for operating the talking device, and generally provided in the upper part of the operation panel 2. Therefore, it is hard for children and people who use a wheelchair to reach the emergency call button.

The detection device 3 is installed in the elevator, and when detecting a radio wave emitted by a mobile terminal 5 in the elevator, transmits a sensing signal indicating detection of the radio wave to the control device 1. The mobile terminal 5 is a mobile phone terminal such as a smartphone and a feature phone. Currently, most people carry a mobile terminal 5. For this reason, when a person carrying a mobile terminal 5 is in the elevator, the detection device 3 detects the radio wave, and transmits the sensing signal to the reporting device 1.

A radio wave emitted by a mobile terminal 5 is, for example, a radio wave in the 800 MHz band used in communication between the mobile terminal 5 and a radio base station, a radio wave according to a Wi-Fi standard with a router, or a radio wave automatically sent from the mobile terminal 5 to a radio base station to notify positional information and the like. The detection device 3 detects these radio waves emitted by the mobile terminal 5 in the elevator.

The external system 7 is a system that remotely monitors the elevator. When receiving a report from the control device 1, the external system 7 of this embodiment notifies an operator or the like. Thereby, the operator arranges for a worker to go there to rescue the person trapped in the elevator, etc.

(Configuration of Control Device)

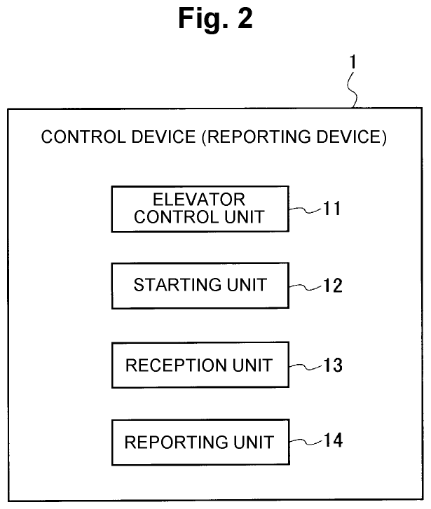

FIG. 2 is a functional block diagram showing a configuration of the control device 1. The control device 1 shown includes an elevator control unit 11, a starting unit 12, a reception unit 13, and a reporting unit 14.

The elevator control unit 11 controls the elevator according to a user's operation, and when sensing an emergency such as an earthquake, a power outage, and a failure, emergently stops (urgently stops) the elevator. Further, when the elevator is recovered, the elevator control unit 11 releases the emergency stop of the elevator, and starts the elevator.

When the elevator is emergently stopped, the starting unit 12 starts the detection device 3 that is installed in the elevator and senses a radio wave emitted by the mobile terminal 5. Specifically, the starting unit 12 starts the detection device 3 at a timing when the elevator control unit 11 emergently stops the elevator. That is, the starting unit 12 starts the detection device 3, with the emergency stop of the elevator as a trigger. Further, when the emergency stop of the elevator is released and the elevator operates normally, the starting unit 12 stops the detection device 3.

The reception unit 13 receives from the detection device 3 the sensing signal indicating that the radio wave from the mobile terminal 5 has been sensed. The sensing signal is a signal indicating that the detection device 3 has sensed the radio wave emitted by the mobile terminal 5 in the elevator.

When the reception unit 13 receives the sensing signal, the reporting unit 14 makes a report to the external system 7. For example, the reporting unit 14 may transmit a signal indicating that a person is trapped in the elevator to the external system 7. Further, the reporting unit 14 may connect the talking device 21 installed in the elevator to the external system 7 so as to be able to have a talk. This enables the person trapped in the elevator due to the emergency stop of the elevator to talk with an operator in the monitoring center.

(Operation of Reporting System)

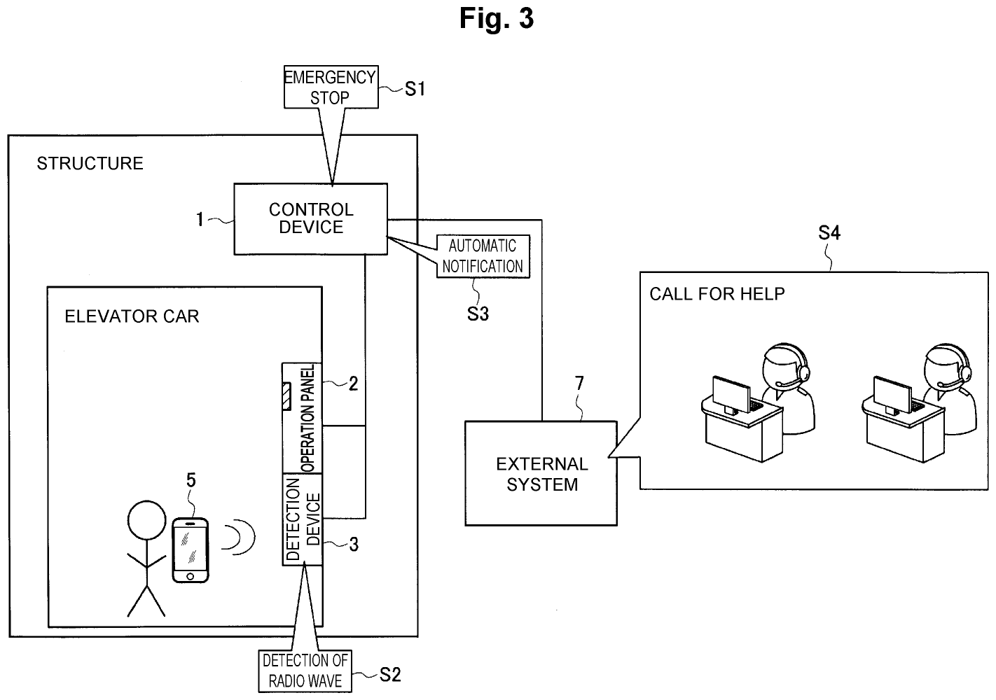

FIG. 3 is an explanatory diagram for explaining operation of the reporting system of this embodiment.

When detecting an emergency such as an earthquake, the control device 1 emergently stops the elevator (S1). At this time, the control device 1 starts the detection device 3 in order to sense a person trapped in the elevator (S1).

When a mobile terminal 5 is in the elevator, the detection device 3 detects the radio wave emitted by the mobile terminal 5, and transmits the sensing signal indicating detection of the radio wave to the control device 1 (S2). In recent years, since most people carry a mobile terminal 5, the detection device 3 will detect the radio wave when a person is in the elevator. In the example shown, a person who has a mobile terminal 5 is trapped in the elevator due to an emergency stop of the elevator, and the detection device 3 transmits the sensing signal to the control device 1.

When receiving the sensing signal from the detection device 3, the control device 1 automatically makes a report to the external system 7 in the monitoring center (S3). The external system 7 in the monitoring center receives the report from the control device 1, and outputs the effect that the report has been made to an output device such as a display to notify an operator. Thereby, the operator makes a call for help such as arranging for a worker to go there to rescue the person trapped in the elevator (S4). Further, the operator may connect to the talking device in the elevator that has emergently stopped, talk with the person in the elevator to grasp the situation of the elevator and the person, and then make a call for help.

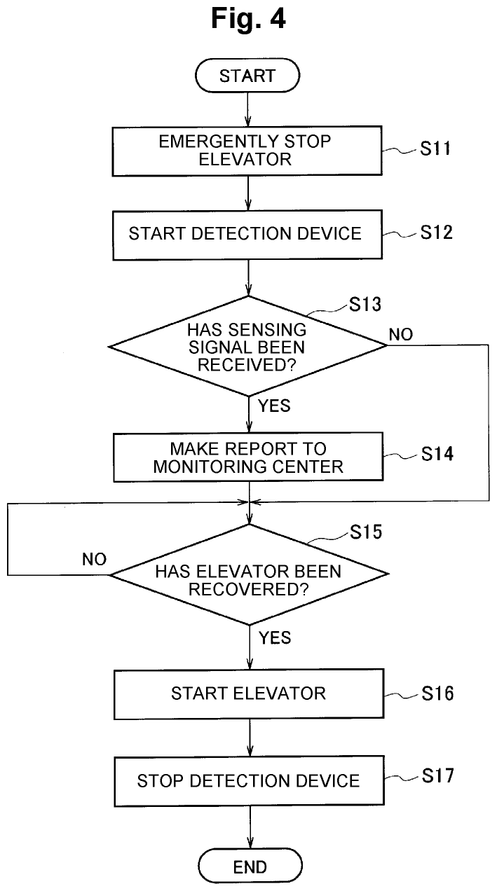

FIG. 4 is a flowchart showing operation of the control device 1 when the elevator is emergently stopped.

When detecting an emergency such as a disaster or a failure, the control device 1 emergently stops the elevator (S11). At this time, the control device 1 starts the detection device 3 in order to determine whether there is a person trapped in the elevator (S12). Thereby, when a person carrying a mobile terminal 5 is trapped in the elevator, the detection device 3 detects the radio wave emitted by the mobile terminal 5, and transmits the sensing signal to the control device 1.

When receiving the sensing signal from the detection device 3 (S13: YES), the control device 1 makes a report to the external system 7 in the monitoring center (S14). For example, the control device 1 transmits a signal indicating that a person is trapped in the elevator to the external system 7. Further, the control device 1 connects the talking device 21 installed in the elevator to the external system 7 so that the person in the elevator can talk with an operator in the monitoring center. When receiving no sensing signal from the detection device 3 (S13: NO), the control device 1 transitions to S15.

Thereafter, when the elevator is recovered (S15: YES), the control device 1 releases the emergency stop of the elevator, and starts the elevator (S16). Then, the control device 1 stops the detection device 3, with the start of the elevator as a trigger (S17).

The control device 1 (the reporting device) of this embodiment described above includes: the starting unit 12 that when emergently stopping an elevator, starts the detection device that is installed in the elevator and senses a radio wave emitted by the mobile terminal; the reception unit 13 that receives from the detection device 3 the sensing signal indicating that a radio wave from the mobile terminal 5 has been sensed; and the reporting unit 14 that makes a report to the external system 7 when the reception unit 13 receives the sensing signal.

Thereby, in this embodiment, in a situation where an elevator has emergently stopped due to a disaster such as an earthquake or a power outage, even when a person who cannot press the emergency call button is trapped in the elevator, it can be reported to the outside such as a monitoring center that the person is in the trapped state.

In order to notify the outside, it is generally necessary to press the emergency call button in the elevator, but the emergency call button is generally provided in the upper part of the operation panel in the elevator car. For this reason, a child, a person who uses a wheelchair, a person who has lost consciousness due to the impact of a disaster, or the like cannot press the emergency call button, and therefore cannot notify the outside of the situation of being trapped in the elevator car. In this embodiment, a person trapped in the elevator can automatically notify the outside of being trapped only by carrying a mobile terminal 5 without any operation such as pressing the emergency call button. Thereby, in this embodiment, even when the emergency call button cannot be pressed, a report can be made to the outside at the time of an emergency stop of the elevator.

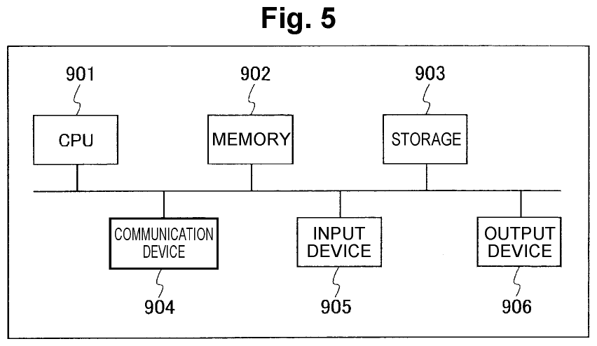

Note that, for example, a general-purpose computer system as shown in FIG. 5 can be used for the control device 1 described above. The computer system shown includes a CPU (central processing unit, processor) 901, a memory 902, a storage 903 (HDD: hard disk drive, SSD: solid state drive), a communication device 904, an input device 905, and an output device 906. The memory 902 and the storage 903 are storage devices. In this computer system, by the CPU 901 executing a predetermined program loaded onto the memory 902, functions of the control device 1 are implemented. Further, the control device 1 may be implemented by one computer, or may be implemented by a plurality of computers. Further, the control device 1 may be a virtual machine implemented on a computer.

The program of the control device 1 can be stored in a computer readable recording medium such as an HDD, an SSD, a USB (universal serial bus) memory, a CD (compact disc), and a DVD (digital versatile disc), or can be delivered via a network.

Note that the present invention is not limited to the above embodiment, and numerous variations can be made within the scope of its spirit.

### REFERENCE SIGNS LIST

1 Control device
11 Elevator control device
12 Starting unit
13 Reception unit
14 Reporting unit
2 Operation panel
21 Talking device
3 Detection device
5 Mobile terminal
7 External system
9 Network

1. A reporting device comprising:
a starting unit, including one or more processors, configured to when emergently stopping an elevator, start a detection device that is installed in the elevator and sense a radio wave emitted by a mobile terminal;
a reception unit, including one or more processors, configured to receive from the detection device a sensing signal indicating that a radio wave from the mobile terminal has been sensed; and
a reporting unit, including one or more processors, configured to make a report to an external system when the reception unit receives the sensing signal.

2. The reporting device according to claim 1, wherein
the reporting unit is configured to transmit a signal indicating that a person is trapped in the elevator to the external system.

3. The reporting device according to claim 1, wherein
the reporting unit is configured to connect a talking device installed in the elevator to the external system so as to be able to have a talk.

4. The reporting device of claim 1, wherein the detection device that is installed in the elevator is configured to transmit a sensing signal when sensing a radio wave emitted by the mobile terminal.

5. A reporting method performed by a reporting device, the reporting method comprising:
when emergently stopping an elevator, starting a detection device that is installed in the elevator and senses a radio wave emitted by a mobile terminal;
receiving from the detection device a sensing signal indicating that a radio wave from the mobile terminal has been sensed; and
making a report to an external system when receiving the sensing signal.

6. A non-transitory computer readable medium storing one or more instructions causing a computer to execute:
when emergently stopping an elevator, starting a detection device that is installed in the elevator and senses a radio wave emitted by a mobile terminal;
receiving from the detection device a sensing signal indicating that a radio wave from the mobile terminal has been sensed; and
making a report to an external system when receiving the sensing signal.

7. The reporting method according to claim 5, comprising:
transmitting a signal indicating that a person is trapped in the elevator to the external system.

8. The reporting method according to claim 5, comprising:
connecting a talking device installed in the elevator to the external system so as to be able to have a talk.

9. The non-transitory computer readable medium according to claim 6, wherein the one or more instructions cause the computer to execute:
transmitting a signal indicating that a person is trapped in the elevator to the external system.

10. The non-transitory computer readable medium according to claim 6, wherein the one or more instructions cause the computer to execute:
connecting a talking device installed in the elevator to the external system so as to be able to have a talk.
